(19) United States
(12) Patent Application Publication
(10) Pub. No.: US 2022/0262270 A1
(43) Pub. Date: Aug. 18, 2022

(54) PICTURE BOOK, PICTURE BOOK PRODUCTION APPARATUS, PICTURE BOOK PRODUCTION INFORMATION ACQUISITION APPARATUS, PICTURE BOOK PRODUCTION METHOD, PICTURE BOOK PRODUCTION INFORMATION ACQUISITION METHOD, PICTURE BOOK PRODUCTION PROGRAM, PICTURE BOOK PRODUCTION INFORMATION ACQUISITION PROGRAM

(71) Applicant: NIPPON TELEGRAPH AND TELEPHONE CORPORATION, Tokyo (JP)

(72) Inventors: Tessei KOBAYASHI, Tokyo (JP); Ai NAKANE, Tokyo (JP)

(73) Assignee: NIPPON TELEGRAPH AND TELEPHONE CORPORATION, Tokyo (JP)

(21) Appl. No.: 17/630,134

(22) PCT Filed: Jul. 30, 2019
(86) PCT No.: PCT/JP2019/029840

§ 371 Date: Jan. 25, 2022

(51) Int. Cl. G09B 19/00; G09B 1/02; G09B 5/02

(52) U.S. Cl. CPC G09B 19/00; G09B 5/02; G09B 1/02

(57) ABSTRACT

Provided is a picture book having a high vocabulary building effect according to each individual infant's interest and state of vocabulary building. A picture book including a double-page spread that includes: a picture that represents one object that a target person is interested in, for a given category; and pictures that represent objects that respectively correspond to a plurality of words that the target person cannot speak, for the category.

### TECHNICAL FIELD

The present invention relates to, for example, a picture book designed to be used by infants to learn a language (to build a vocabulary).

### BACKGROUND ART

Non Patent Literature 1 is a picture book that is specialized for the target infant. Non Patent Literature 1 realizes a picture book specialized for the target infant by using the name or nickname of the target infant as the name of the main character of the story. A Non Patent Literature 2 includes, in addition to the elements of Non-Patent Literature 1, the date of birth and a message from a parent, so that the picture book specialized for the target infant includes elements of the celebration of the birth of the infant.

### CITATION LIST

### Non Patent Literature

[NPL 1] “Orijinaru bukku no peji e yokoso” [online], Yuushisya, Inc., [searched on Jul. 18, 2019], the Internet, <URL: https://www.yuubook.com/oribook.html>
[NPL 2] “Shutsusan iwai purezento naire ehon [onamae shussan-bi nado irete kanryo]”, [online], Anata no ehon dotto Komu (Cresson Breath Co., Ltd), [searched on Jul. 18, 2019], the Internet, <URL: https://www.anatano-ehon.com/SHOP/130.html>

### SUMMARY OF THE INVENTION

### Technical Problem

In the picture books according to Non-Patent Literatures 1 and 2, the name of the main character of the story is the name or nickname of the target infant, and it is assumed that the target infant can read the picture book with interest because they are featured in the picture book. However, the picture books of according to Non-Patent Literatures 1 and 2 are created based on certain fixed contents and elements other than the name of the main character. Therefore, it is quite possible that a thing that the target infant is interested in will not appear, or only things that are known to the target infant will appear, or only things that are too difficult for the target infant will appear. Therefore, there is a problem in that the picture books according to Non-Patent Documents 1 and 2 do not necessarily contribute to the educational aspect such as building the target infant's the vocabulary.

An object of the present invention is to provide a picture book having a high vocabulary building effect according to each individual infant's interest and state of vocabulary building.

### Means for Solving the Problem

To solve the above-described problem, according to one aspect of the present invention, a picture book includes a double-page spread that includes a picture that represents one object in which a target person is interested (hereinafter referred to as an “object of interest”) for a given category, and unacquired word pictures that are pictures that represent objects that respectively correspond to a plurality of words that the target person cannot speak, for the category.

To solve the above-described problem, in another aspect of the present invention, a picture book production apparatus includes: a picture book material storage unit that stores, in advance, for a given category, pictures respectively representing a plurality of candidates for an object that an infant targeted by a picture book is interested in (hereinafter referred to as “object-of-interest candidates”), and pictures respectively representing a plurality of candidates for objects corresponding to words that the infant targeted by the picture book cannot speak (hereinafter referred to as “unacquired word object candidates”); a personalized material acquisition unit that acquires, for the category, a picture representing one object that the target person is interested in (hereinafter referred to as an “object of interest”) from among the pictures respectively representing the plurality of object-of-interest candidates stored in the picture book material storage unit, and acquires, for the category, unacquired word pictures that are pictures representing objects corresponding to the plurality of words that the target person cannot speak from among the pictures respectively representing the plurality of unacquired word object candidates stored in the picture book material storage unit; a page image generation unit that generates images for a double-page spread that includes the picture representing the object of interest and the plurality of unacquired word pictures selected by the personalized material acquisition unit; and a picture book production unit that produces a picture book that includes a double-page spread formed by visualizing the images for the double-page spread generated by the page image generation unit.

To solve the above-described problem, in another aspect of the present invention, a picture book production information acquisition apparatus includes: a picture book material storage unit that stores, in advance, for a given category, a word that represents an object for a plurality of candidates for the object that an infant targeted by a picture book is interested in (hereinafter referred to as “object-of-interest candidates”), and words that represent objects for a plurality of candidates for the objects corresponding to words that the infant targeted by the picture book cannot speak (hereinafter referred to as “unacquired word object candidates”); a word-of-interest selection unit that causes a display unit to display, as options, all of the words that represent the object-of-interest candidates for the category stored in the picture book material storage unit, causes an input unit to receive a selection operation from a user selecting one of the words that represent the object-of-interest candidates displayed by the display unit, and selects, as a word that represents an object of interest of the target person, a word that represents an object-of-interest candidate for which the input unit has received the selection operation; and an unacquired word selection unit that causes the display unit to display the words that represent the unacquired word object candidates for the category stored in the picture book material storage unit, causes the input unit to receive a selection operation from the user selecting, for each of the unacquired word object candidates displayed by the display unit, whether or not the target person can speak the unacquired word object candidate, and selects, as unacquired words, all of the words that represent unacquired word object candidates for which the input unit has received a selection operation indicating that the target person cannot speak words corresponding thereto.

To solve the above-described problem, another aspect of the present invention provides a picture book production method, wherein, for a given category, pictures respectively representing a plurality of candidates for an object that an infant targeted by a picture book is interested in (hereinafter referred to as “object-of-interest candidates”), and pictures respectively representing a plurality of candidates for objects corresponding to words that the infant targeted by the picture book cannot speak (hereinafter referred to as “unacquired word object candidates”) have been stored in advance in a picture book material storage unit, the picture book production method including: a personalized material acquisition step of acquiring, for the category, a picture representing one object that the target person is interested in (hereinafter referred to as an “object of interest”) from among the pictures respectively representing the plurality of object-of-interest candidates stored in the picture book material storage unit, and acquiring, for the category, unacquired word pictures that are pictures representing objects corresponding to the plurality of words that the target person cannot speak from among the pictures respectively representing the plurality of unacquired word object candidates stored in the picture book material storage unit; a page image generation step of generating images for a double-page spread that includes the picture representing the object of interest and the plurality of unacquired word pictures selected in the personalized material acquisition step; and a picture book production step of producing a picture book that includes a double-page spread formed by visualizing the images for the double-page spread generated in the page image generation step.

To solve the above-described problem, another aspect of the present invention provides a picture book production information acquisition method, wherein, for a given category, a word that represents an object for a plurality of candidates for the object that an infant targeted by a picture book is interested in (hereinafter referred to as “object-of-interest candidates”), and words that represent objects for a plurality of candidates for the objects corresponding to words that the infant targeted by the picture book cannot speak (hereinafter referred to as “unacquired word object candidates”) have been stored in advance in a picture book material storage unit, the picture book production information acquisition method including: a word-of-interest selection step of causing a display unit to display, as options, all of the words that represent the object-of-interest candidates for the category stored in the picture book material storage unit, causing an input unit to receive a selection operation from a user selecting one of the words that represent the object-of-interest candidates displayed by the display unit, and selecting, as a word that represents an object of interest of the target person, a word that represents an object-of-interest candidate for which the input unit has received the selection operation; and an unacquired word selection step of causing the display unit to display the words that represent the unacquired word object candidates for the category stored in the picture book material storage unit, causing the input unit to receive a selection operation from the user selecting, for each of the unacquired word object candidates displayed by the display unit, whether or not the target person can speak the unacquired word object candidate, and selecting, as unacquired words, all of the words that represent unacquired word object candidates for which the input unit has received a selection operation indicating that the target person cannot speak words corresponding thereto.

### Effects of the Invention

With the present invention, it is possible to achieve a high vocabulary building effect according to each individual infant's interest and state of vocabulary building.

### BRIEF DESCRIPTION OF DRAWINGS

FIG. 1 is a diagram illustrating the covers of picture books.

FIG. 2 is a diagram illustrating introduction parts of the picture books.

FIG. 3 is a diagram illustrating third double-page spreads of main stories of the picture books.

FIG. 4 is a diagram illustrating second double-page spreads of the main stories of the picture books.

FIG. 5 is a diagram illustrating first double-page spreads of the main stories of the picture books.

FIG. 6 is a diagram illustrating closing parts of the picture books.

FIG. 7 is a diagram illustrating information parts of the picture books.

FIG. 8 is a diagram illustrating a functional configuration of a picture book production information acquisition apparatus.

FIG. 9 is a diagram illustrating processing procedures performed by the picture book production information acquisition apparatus.

FIG. 10 is a diagram illustrating a functional configuration of a picture book production apparatus.

FIG. 11 is a diagram illustrating processing procedures performed by the picture book production apparatus.

FIG. 12 is a diagram illustrating a functional configuration of a picture book production apparatus.

FIG. 13 is a diagram illustrating processing procedures performed by the picture book production apparatus.

### DESCRIPTION OF EMBODIMENTS

The following describes embodiments of the present invention with reference to the drawings. A first embodiment describes a picture book, a second embodiment describes an apparatus and a method for acquiring information that is to be used to manufacture a picture book, and third and fourth embodiments describe an apparatus and a method for producing the picture book according to the first embodiment.

### First Embodiment

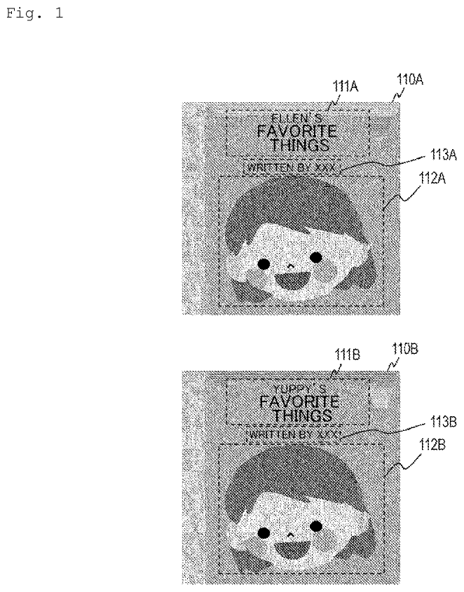

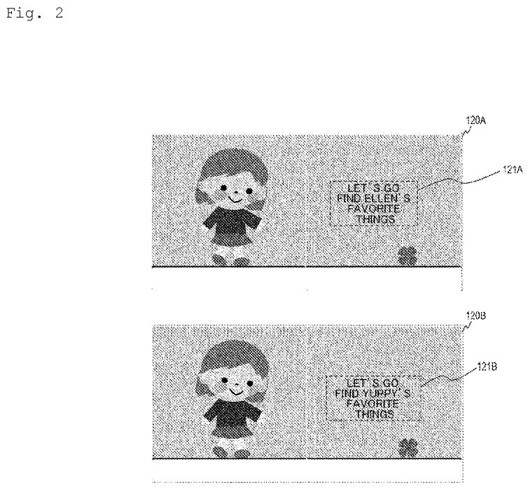

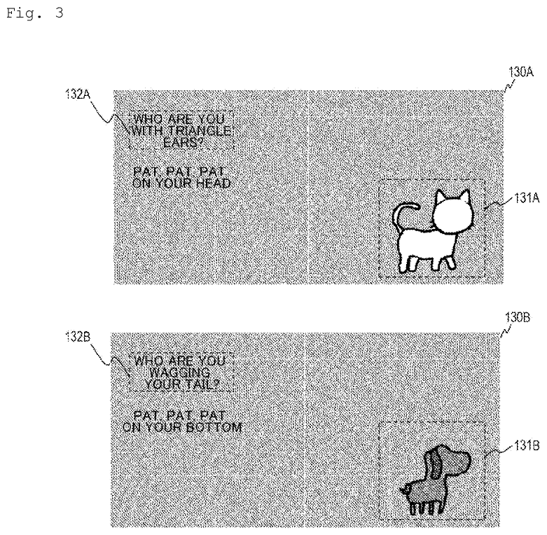

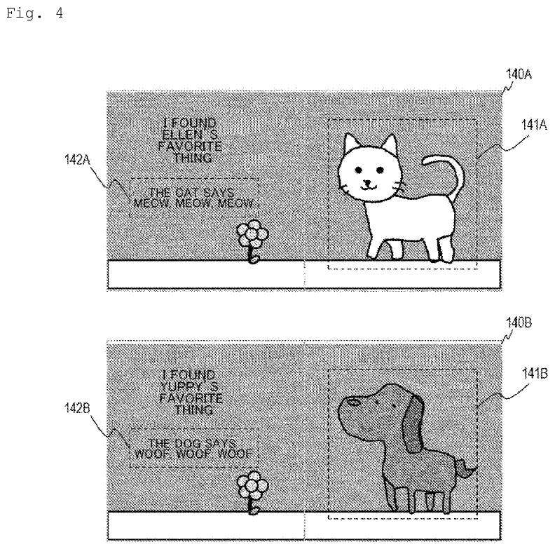

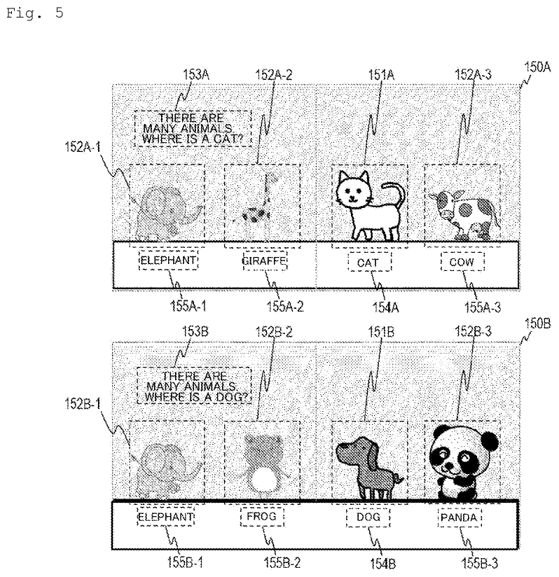

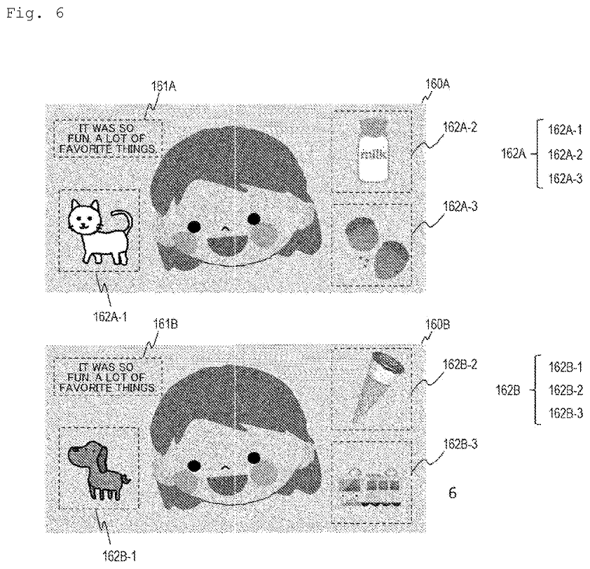

Each picture book according to the first embodiment includes, for example, a cover 110A, 110B illustrated in FIG. 1, an introduction part 120A, 120B illustrated in FIG. 2, a main story part that includes a third double-page spread 130A, 130B illustrated in FIG. 3, a second double-page spread 140A, 140B illustrated in FIG. 4, and a first double-page spread 150A, 150B illustrated in FIG. 5, a closing part 160A, 160B illustrated in FIG. 6, and a back cover, in the stated order. However, each picture book according to the present invention is characterized in being specialized for the target infant (hereinafter referred to as a target person), and therefore each reference number in each figure is given A or B that are identifiers specifying the two illustrated target persons, “Ellen” and “Puppy”. That is, in this specification, although the reference number with A and the reference number with B are written with “,” being interposed therebetween in the respective descriptions of the parts of the picture books, it does not mean that one picture book includes both the components indicated by the reference numbers to which A is assigned and the components indicated by the reference numbers to which B is assigned. For example, the picture book for the target person “Ellen” includes the cover 110A illustrated in FIG. 1, the introduction part 120A illustrated in FIG. 2, the main story part that includes the third double-page spread 130A illustrated in FIG. 3, the second double-page spread 140A illustrated in FIG. 4, and the first double-page spread 150A illustrated in FIG. 5, the closing part 160A illustrated in FIG. 6, and the back cover (not shown), in the stated order. Also, for example, the picture book for the target person “Yuppy” includes the cover 110B illustrated in FIG. 1, the introduction part 120B illustrated in FIG. 2, the main story part that includes the third double-page spread 130B illustrated in FIG. 3, the second double-page spread 140B illustrated in FIG. 4, and the first double-page spread 150B illustrated in FIG. 5, the closing part 160B illustrated in FIG. 6, and the back cover (not shown), in the stated order.

Note that the pieces of information described later regarding the target person, included in the picture book according to the first embodiment, i.e., pieces of information regarding the target person's name or nickname, and sex, objects that the target person is interested in, and words that the target person cannot speak, are obtained from a fosterer of the target person, using the picture book production information acquisition apparatus according to a second embodiment or Japanese Patent Application Publication No. 2019-101255.

[Cover 110A, 110B]

As illustrated in FIG. 1, the cover 110A, 110B includes a title 111A, 111B, and may include a picture 112A, 112B representing an infant, an author's name 113A, 113B, and so on. For example, the tile is a description that includes the target person's name or nickname and specifies the fact that objects that the target person is interested in are mentioned, such as the title 111A in FIG. 1, “Ellen's favorite things”, or the title 111B in FIG. 1, “Yuppy's favorite things”. Considering the fact that the target person is an infant, it is preferable to adopt the target person's favorite things as objects that the target person is interested in. The picture 112A, 112B representing the infant is, for example, a picture that imitates the face of the infant, and may be a picture that matches the sex of the target person. Both the target persons “Ellen” and the target person “Yuppy” are female infants, the picture 112A representing the infant in FIG. 1 and the picture 112B representing the infant in FIG. 1 are pictures that each imitate the face of a female infant. Note that the cover 110A, 110B may include pictures and descriptions other than those described above.

[Introduction Part 120A, 120B]

As shown in FIG. 2, the introduction part 120A, 120B includes, an introduction description 121A, 121B. An introduction description is a description that includes the target person's name or nickname and specifies the fact that the story is about finding objects that the target person is interested in, such as the prorogue description 121A in FIG. 2, “Let's go find Ellen's favorite things”, and the prorogue description 121B in FIG. 2, “Let's go find Yuppy's favorite things”. Note that the introduction part 120A, 120B may include pictures and descriptions other than those described above.

[Main Story Part]

The main story part includes the first double-page spread 150A, 150B (see FIG. 5). The main story part may include the second double-page spread 140A, 140B (see FIG. 4) before the first double-page spread 150A, 150B, and may also include the third double-page spread 130A, 130B (see FIG. 3) before the second double-page spread 140A, 140B. Also, a picture book may include a plurality of main story parts. When a picture book includes a plurality of main story parts, each main story part belongs to a different category. Considering the fact that the target person is an infant, it is preferable that the categories are simple and broad. For example, at least one of three categories, namely “animal”, “food and drink”, and “others (i.e., objects that are neither animals nor food and drink)”, may be used as a category.

Each main story part refers to one object that the target person is interested in and objects respectively corresponding to a plurality of words that the target person cannot speak, for the category to which the main story part corresponds. In the following description, an object that the target person is interested in is also referred to as an “object of interest”, a word that the target person cannot speak is also referred to as an “unacquired word”, and an object corresponding to the word that the target person cannot speak is also referred to as an “unacquired word object”. Even when a plurality of double-page spreads are included in one main story part, the object of interest referred to in all of the double-page spreads included in one main story part are the same.

[[First Double-Page Spread 150A, 150B in Main Story Part]

[[[Word-of-Interest Picture 151A, 151B and Unacquired Word Picture 152A-n, 152B-n]]]

As illustrated in FIG. 5, the first double-page spread 150A, 150B in the main story part includes, for a given category, at least a picture 151A, 151B that represents one object that the target person is interested in (i.e., an object of interest), and pictures 152A-n, 152B-n (n is an integer no less than 1 and no greater than N, and N is an integer no less than 2) that represent objects that respectively correspond to a plurality of words that the target person cannot speak (i.e. unacquired word objects). In the following description, a picture represented by an object that the target person is interested in, included in the first double-page spread 150A, 150B, is referred to as a “word-of-interest picture”, and a picture that represents an object corresponding to a word that the target person cannot speak, included in the first double-page spread 150A, 150B, is referred to as an “unacquired word picture”. The composition of the first double-page spread 150A, 150B is designed to include the word-of-interest picture and the unacquired word pictures in the same category so as to be given equal importance, and achieve the effect of making the target person interested in not only the word-of-interest picture but also the unacquired word pictures to enable the target person to learn the words that represent the unacquired word objects and speak them.

Preferably, N is approximately 3. That is to say, it is preferable that the first double-page spread 150A includes one Word-of-interest picture 151A and three unacquired word pictures 152A-1, 152A-2, and 152A-3, and the first double-page spread 150B includes one word-of-interest picture 151B and three unacquired word pictures 152B-1, 152B-2, and 152B-3. When the first double-page spread 150A includes three unacquired word pictures 152A-1, 152A-2, and 152A-3, and the first double-page spread 150B includes three unacquired word pictures 152B-1, 152B-2, and 152B-3, it is preferable that pictures of objects corresponding to three words that the target person cannot speak and whose average acquisition ages are different are the three unacquired word pictures. That is to say, when three unacquired word pictures 152A-1, 152A-2, and 152A-3 and three unacquired word pictures 152B-1, 152B-2, and 152B-3 are pictures αₚ, βₚ, and γₚ that represent objects respectively corresponding to three words α, β, and γ that the target person cannot speak, the average acquisition age of the word α<the average acquisition age of the word β<the average acquisition age of the word γ is satisfied. In other words, the average acquisition age of the word α is smaller than the average acquisition age of the word β, and the average acquisition age of the word γ is larger than the average acquisition age of the word β. This aim is to achieve the effect of enabling the target person to learn and speak the word α at the lowest difficulty level, and further, to achieve the effect of enabling the target person to learn and speak the words β and γ at the difficulty levels higher than the word α, by making the target person interested in the picture αₚ corresponding to the word α that the target person is likely to learn immediately, the picture βₚ corresponding to the word β that the target person is likely to learn a little later, and the picture γₚ corresponding to the word γ that the target person is likely to learn even later at the same time.

Note that an average acquisition age of a word is the age at which an average person acquires the word. When the target is an infant as in the case of a picture book, the age in months is often used as the age. However, the age in years or the age in days may be used instead. An example of the average acquisition age is an X % acquisition age in months at which X % of average people acquire the word, where X is a predetermined number that satisfies 0≤X≤100. X is 50, for example.

FIG. 5 illustrates the first double-page spread 150A for the target person “Ellen” and the first double-page spread 150B for the target person “Yuppi” when the category is “animal”.

The word-of-interest picture 151A in FIG. 5 is a picture of a “cat” that is a favorite animal of the target person “Ellen”, and the three unacquired word pictures 152A-1, 152A-2, and 152A-3 in FIG. 5 are pictures of an “elephant”, a “giraffe”, and a “cow” that are animals corresponding to words that the target person “Ellen” cannot speak. The average acquisition age in months of the word “elephant” (in Japanese) is 24.05, the average acquisition age in months of the word “giraffe” (in Japanese) is 26.15, and the average acquisition age in months of the word “cow” (in Japanese) is 28.36. The first double-page spread 150A in FIG. 5 aims to achieve the effect of enabling the target person “Eren” to learn and speak at least the word “elephant” that is at the lowest difficulty level, and further achieve the effect of enabling the target person “Ellen” to learn and speak the words “giraffe” and “cow” at the higher difficulty level than the word “elephant”.

The word-of-interest picture 151B in FIG. 5 is a picture of a “dog” that is a favorite animal of the target person “Yuppy”, and the three unacquired word pictures 152B-1, 152B-2, and 152B-3 in FIG. 5 are pictures of an “elephant”, a “frog”, and a “panda” that are animals corresponding to words that the target person “Yuppy” cannot speak. The average acquisition age in months of the word “elephant” (in Japanese) is 24.05, the average acquisition age in months of the word “frog” (in Japanese) is 26.54, and the average acquisition age in months of the word “panda” (in Japanese) is 26.92. The first double-page spread 150B in FIG. 5 aims to achieve the effect of enabling the target person “Yuppy” to learn and speak at least the word “elephant” that is at the lowest difficulty level, and further achieve the effect of enabling the target person “Ellen” to learn and speak the words “frog” and “panda” at the higher difficulty level than the word “elephant”.

Note that each of the first double-page spreads 150A and 150B includes at least three pictures as pictures that represent objects, namely the word-of-interest picture 151A or 151B and a plurality of unacquired word pictures 152A-n or 152B-n. Therefore, it is preferable that at least one picture of either the word-of-interest picture or the plurality of unacquired word pictures has a different base color. Even though the base color itself does not have a direct influence on the effect of enabling the target person to learn and speak the word, it can be envisaged that a picture book with an interesting picture attracts more attention of the target person. Therefore, an aim is to make the target person more interested in the picture book and indirectly improve the effect of enabling the target person to learn and speak words, by giving variations to the base color of the pictures included in the first double-page spreads 150A and 150B.

[[[Question Description 153A, 153B]]]

As illustrated in FIG. 5, it is preferable that the first double-page spread 150A, 150B of the main story part includes a question description 153A, 153B to ask the target person which object the target person is interested in (i.e., an object of interest). The question 153A, 153B is, for example, a question description for asking the target person “Ellen” which is her favorite animal “cat”, such as the question description 153A: “where is a cat?” in FIG. 5, or, for example, a question description for asking the target person “Yuppy” which is her favorite animal “dog”, such as the question description 153B: “where is a dog?” in FIG. 5. This aim is to achieve the effect of making the target person interested in the unacquired word objects and enable the target person to learn and speak the unacquired words by the question description 153A, 153B making it necessary for the target person to visually check not only the word-of-interest picture but also the unacquired word pictures to see which is the object of interest.

Note that, as with “there are many animals” in the questions 153A and 153B in FIG. 5, a question description may include a sentence that indicates the fact that a plurality of objects in the category corresponding to the main story part are included in the first double-page spread 150A, 150B. This sentence aims to achieve the effect of enabling the target person to learn that unacquired word objects represented by the unacquired word pictures 152A-n, 152B-n included in the first double-page spread 150A, 150B belong to the same category as the object of interest represented by the word-of-interest picture 151A, 151B included in the first double-page spread 150A, 150B.

[[[Character Notation 154A, 154B Representing Object of Interest, and Character Notations 155A-n, 155B-n of Unacquired Words]]]

As illustrated in FIG. 5, the first double-page spread 150A, 150B in the main story part may include a character notation 154A, 154B that represents the object of interest, in the vicinity of the picture 151A, 151B of the object of interest, and may include character notations 155A-n, 155B-n of the unacquired words, respectively in the vicinity of the pictures 152A-n, 152B-n of the pictures of the unacquired word objects. For example, as illustrated in FIG. 5, the character notation 154A indicating “cat” may be included immediately below the picture 151A of a “cat” that is a favorite animal of the target person “Ellen”, and character notations 155A-1, 155A-2, and 155A-3 indicating “elephant”, “giraffe”, and “cow” may be included immediately below the pictures 152A-1, 152A-2, and 152A-3 of an “elephant”, a “giraffe”, and a “cow” respectively, which are animals corresponding to words that the target person “Ellen” cannot speak. Also, for example, as illustrated in FIG. 5, the character notation 154B indicating “dog” may be included immediately below the picture 151B of a “dog” that is a favorite animal of the target person “Yuppy”, and character notations 155B-1, 155B-2, and 155B-3 indicating “elephant”, “frog”, and “panda” may be included immediately below the pictures 152B-1, 152B-2, and 152B-3 of an “elephant”, a “frog”, and a “panda” respectively, which are animals corresponding to words that the target person “Yuppy” cannot speak.

Note that the first double-page spread 150A, 150B preferably does not include a picture or description other than those described above, and it is necessary that such a picture or description, even if included, is merely a decorative picture, and is not a picture of an object.

[[Second Double-Page Spread 140A, 140B]]

The second double-page spread 140A, 140B is a page that is included before the first double-page spread 150A, 150B in the main story part of the picture book, as illustrated in FIG. 4, only includes a picture 141A, 141B of the object of interest for the category to which the main story part corresponds (i.e., the same category as the first double-page spread 150A, 150B), and includes a sentence 142A, 142B regarding the object of interest as well. Considering the fact that the target person is an infant, it is not preferable that one main story part includes many double-page spreads. Therefore, it is preferable that the second double-page spread 140A, 140B is included immediately before the first double-page spread 150A, 150B in the main story part.

FIG. 4 illustrates the second double-page spread 140A for the target person “Ellen” and the second double-page spread 140B for the target person “Yuppi” when the category is “animal”. For the “animal” category, the second double-page spread 140A in FIG. 4 only includes a picture 141A of a “cat” that is a favorite animal of the target person “Ellen”, and does not include pictures of animals other than a “cat”. Furthermore, the second double-page spread 140A in FIG. 4 includes a sentence 142A regarding a “cat” that is the favorite animal of the target person “Ellen”, saying “the cat says meow, meow, meow”. For the “animal” category, the second double-page spread 140B in FIG. 4 only includes a picture 141B of a “dog” that is a favorite animal of the target person “Yuppy”, and does not include pictures of animals other than a “dog”. Furthermore, the second double-page spread 140B in FIG. 4 includes a sentence 142B regarding a “dog” that is the favorite animal of the target person “Yuppy”, saying “the dog says woof, woof, woof”.

Note that the second double-page spread 140A, 140B may include a picture or description other than those described above as long as it is not included in the targeted category. However, it is preferable that such a picture or description is merely a decorative picture so that the target person is not distracted from the picture 141A, 141B of the object of interest.

The first double-page spread 150A, 150B included in the main story part after the second double-page spread 140A, 140B includes, for the category targeted by the main story part, not only the picture that the target person is interested in, but also a plurality of pictures of objects corresponding to words that the target person cannot speak, and is difficult for the target person. When the first double-page spread 150A, 150B includes question description 153A, 153B, or when a fosterer asks the same question as the question description 153A, 153B, for example, the target person needs to find a picture of an object of interest from a plurality of existing pictures, which is also difficult for the target person. Therefore, by including the second double-page spread 140A, 140B, which only includes the picture 141A, 141B of the object of interest for the target category and includes the sentence 142A, 142B regarding the object of interest, before the first double-page spread 150A, 150B, it is possible to substantially lower the difficulty level of the first double-page spread 150A, 150B for the target person.

[[Third Double-Page Spread 130A, 130B]]

The third double-page spread 130A, 130B in the main story part is pages that are included in the main story part of the picture book before the second double-page spread 140A, 140B, as shown in FIG. 3, for the category to which the main story part corresponds (i.e., the same category as the first double-page spread 150A, 150B and the second double-page spread 140A, 140B), only includes a picture 131A, 131B of the object of interest, and includes a question description 132A, 132B about the object of interest as well. Considering the fact that the targeted person is an infant, it is not preferable that one main story part includes many double-page spreads. Therefore, it is preferable that the third double-page spread 130A, 130B is included immediately before the second double-page spread 140A, 140B in the main story part. It is also preferable that the picture 131A, 131B of the object of interest in the third double-page spread 130A, 130B is different from the word-of-interest picture 151A, 151B in the first double-page spread 150A, 150B and the picture 141A, 141B of the object of interest in the second double-page spread 140A, 140B.

Note that the question description 132A, 132B is preferably a question for asking about a feature of the object of interest, and may be a question description for asking about a feature of the object of interest and asking what is the object of interest. A feature of the object of interest is a feature that is perceived due to the presence of the object of interest, and may be, for example, a visual feature of the object of interest itself, a visual feature and an auditory feature that are perceived due to the movement of the object of interest, a tactile feature that is perceived when the target person touches the object of interest, a taste feature that is perceived when the target person eats or drinks the object of interest, or an olfactory feature that is perceived when the object of interest emits an odor. The question description 132A, 132B may include a plurality of features of the object of interest, or include a plurality of types of features of the object of interest.

FIG. 3 illustrates the third double-page spread 130A for the target person “Ellen” and the third double-page spread 130B for the target person “Yuppi” when the category is “animal”. For the “animal” category, the third double-page spread 130A in FIG. 3 only includes a picture 131A of a “cat” that is a favorite animal of the target person “Ellen”, and does not include pictures of animals other than a “cat”. Furthermore, the third double-page spread 130A in FIG. 3 includes a question description 132A which is “who are you with triangle ears?” to ask about a visual feature of the “cat” that is a favorite animal of the target person “Ellen”. For the “animal” category, the third double-page spread 130B in FIG. 3 only includes a picture 131B of a “dog” that is a favorite animal of the target person “Yuppy”, and does not include pictures of animals other than a “dog”. Furthermore, the third double-page spread 130B in FIG. 3 includes a question description 132B which is “who are you wagging your tail?” to ask about a visual feature of the “dog” that is a favorite animal of the target person “Yuppy”. Also, when the favorite animal of the target person is “fish”, the third double-page spread only includes the picture of a “fish” that is the favorite animal of the target person for the “animal” category, does not include pictures of animals other than a fish, and includes a question description which is “who are you splashing and swimming?” to ask about an auditory feature of the “fish” that is a favorite animal of the target person.

Note that the third double-page spread need only include at least the picture of the object of interest and a question description that is a description for asking a question about the object of interest, and a sentence regarding the object of interest, such as “pat, pat, pat on your head” in FIG. 3 or “pat, pat, pat on your bottom” in FIG. 3 may be included in the third double-page spread 130A, 130B. However, the third double-page spread 130A, 130B is for asking a question about the object of interest, and therefore a picture that has a meaning other than the picture 131A, 131B of the object of interest should not be included therein.

In the first double-page spread 150A, 150B and the second double-page spread 140A, 140B in the main story part, one specific object is targeted as the object that the target person is interested in for the target category of the main story part. Although the object of interest targeted in the main story part is necessarily an object that the target person is interested in, the number of objects that the target person is interested in for the target category of the main story part is not limited to one. For example, the target person “Ellen” may also like a “dog”, and the target person “Yuppy” may also like a “cat”. Therefore, by including the third double-page spread 130A, 130B before the second double-page spread 140A, 140B, it is possible to enable the target person to specify the object of interest that is targeted in the main story part, and attract the target person to the object of interest targeted in the main story part.

[Closing Part 160A, 160B]

As illustrated in FIG. 6, each of the closing parts 160A and 160B includes a closing description 161A, 161B and pictures 162A, 162B of the objects of interest. A closing description is a description that identifies the story as a story about an object that the target person is interested in, such as “It was so fun. A lot of favorite things.” in the closing description 161A, 161B in FIG. 6, for example. The ending description 161A, 161B may include the name or nickname of the target person. The pictures 162A, 162B of the objects of interest are pictures of the objects of interest in the main story part included in the picture book. When the picture book includes a plurality of main story parts, the closing part 160A, 160B may include a plurality of pictures that are the pictures of the respective objects of interest in the plurality of main story parts included in the picture book, as pictures 162A, 162B of the objects of interest. However, although the closing part 160A, 160B may include a picture or description other than those described above, the closing part 160A, 160B only includes the pictures 162A, 162B of the objects of interest for the categories of the main story parts included in the picture book, and does not include a picture of an object other than the objects of interest.

FIG. 6 illustrates the closing part 160A for the target person “Ellen” and the closing part 160B for the target person “Yuppy” when the picture book includes three categories, namely “animal”, “food and drink”, and “others”. The closing part 160A in FIG. 6 includes three pictures, namely the picture 162A-1 of a “cat” that is an animal that the target person “Ellen” likes, the picture 162A-2 of “milk” that is food and drink that the target person “Ellen” likes, and the picture 162A-3 of an “acorn” that is another object that the target person “Ellen” likes, as the pictures 162A of the objects of interest. The closing part 160B in FIG. 6 includes three pictures, namely the picture 162B-1 of a “dog” that is an animal that the target person “Yuppy” likes, the picture 162B-2 of “ice cream” that is food and drink that the target person “Yuppy” likes, and the picture 162B-3 of a “train” that is another object that the target person “Ellen” likes, as the pictures 162B of the objects of interest.

[Back Cover]

Although not illustrated, the back cover need only include pictures and characters according to the need as in well-known picture books.

<Modification of First Embodiment>

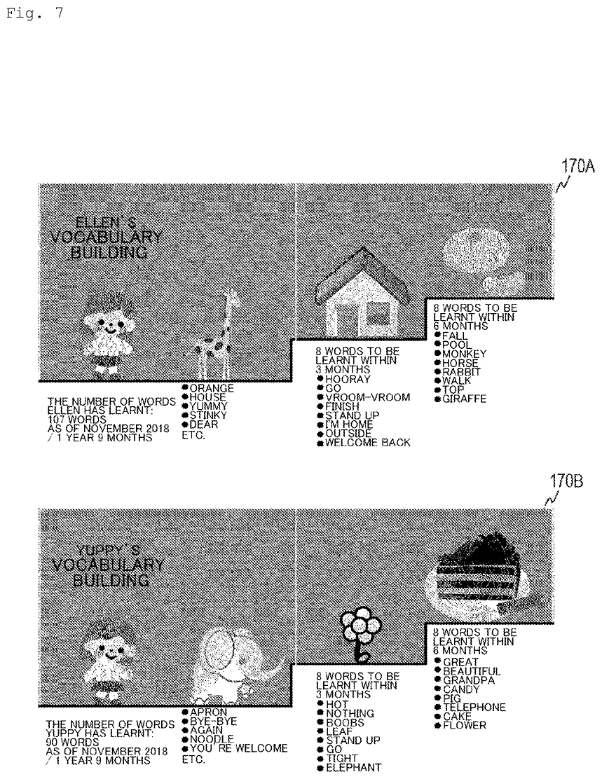

The picture book may include an information part that is a page containing information regarding the acquisition of words by the target person as a page for fosterer. In such a case, the picture book may include an information part 170A, 170B illustrated in FIG. 7, after the closing part 160A, 160B and before the back cover, i.e., between the closing part 160A, 160B and the back cover.

[Information Part 170A, 170B]

The information part 170A, 170B is a page that includes information regarding the build of a word by the target person. As illustrated in FIG. 7, the information part 170A, 170B includes the name or nickname of the target person, the number of words that the target person learned, examples of words that the target person already learned, and examples of words that are expected to be learned by the target person in the future. The words that are expected to be learned by the target person in the future are obtained based on information regarding the age of the target person, the words that the target person has learned so far, and the average acquisition age of each of the words collected by the inventors, for example. Information acquired by a vocabulary building apparatus disclosed in Japanese Patent Application Publication No. 2019-101255 may be used to acquire the number of words that the target person has learned so far and examples of the examples of words that the target person already learned. Note that words that are expected to be learned by the target person in the future may be illustrated for each of a plurality of periods as in FIG. 7.

### Second Embodiment

In order to manufacture the picture book according to the first embodiment, pieces of information regarding objects that the target person is interested in and words that the target person cannot speak is required, for example. The second embodiment describes a picture book production information acquisition apparatus that acquires these pieces of information, and operation thereof.

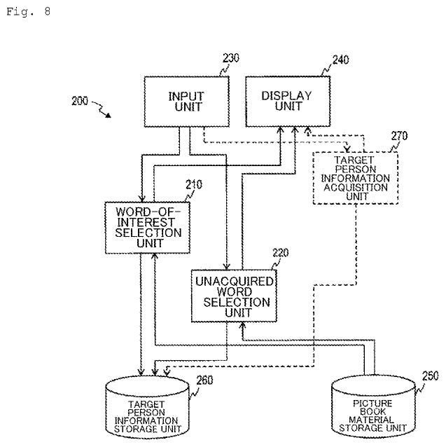

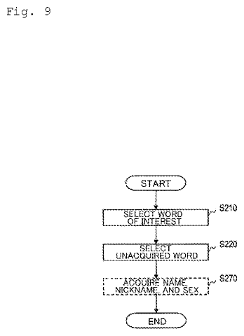

As with a picture book production information acquisition apparatus 200 illustrated in FIG. 8, a picture book production information acquisition apparatus according to the second embodiment includes, for example, a word-of-interest selection unit 210, an unacquired word selection unit 220, an input unit 230, a display unit 240, a picture book material storage unit 250, and a target person information storage unit 260. The picture book production information acquisition apparatus 200 according to the second embodiment is designed for a user such as a fosterer of a target person to select one of a plurality of candidates for the object of interest as an object of interest, and select an unacquired word from a plurality of candidates for the unacquired words for each category to be included in the picture book of the first embodiment, and carries out steps S210 and S220 illustrated in FIG. 9. As described above in the first embodiment, one category may be included or a plurality of categories may be included in the picture book. That is to say, the picture book production information acquisition apparatus 200 carries out steps S210 and S220 illustrated in FIG. 9 for at least one given category. Note that the picture book production information acquisition apparatus 200 according to the second embodiment may also include a target person information acquisition unit 270 as illustrated with a dotted line in FIG. 8, and carry out step S270 as illustrated with a dotted line in FIG. 9.

[Picture Book Material Storage Unit 250]

The picture book material storage unit 250 stores, for each of the categories to be included in the picture book, a plurality of candidates for the word that represents the object of interest, and a plurality of candidates for the unacquired words, in advance.

For example, the picture book material storage unit 250 stores fifteen candidates for the word that represents the object of interest, for each of three categories, namely “animal”, “food and drink”, and “others”. Candidates for the word that represents the object of interest are nouns included in the respective categories, are included in the top tier of the ranking of objects that infants are interested in, as a result of a questionnaire survey of fosterers carried out in advance, and have been manually selected so that the words can be easily understood from pictures. In addition, for example, the picture book material storage unit 250 stores twenty candidates for the unacquired words for each of three categories, namely “animal”, “food and drink”, and “others”. Candidates for the unacquired words are nouns included in the respective categories, words whose average acquisition age is within a predetermined age range that is based on the target age of the picture book (for example, the age of 18 to 32 months), and have been manually selected so that the words can be easily understood from pictures.

Note that the numbers of candidates for the word that represents the object of interest candidates for the unacquired words to be stored in the picture book material storage unit 250 need not be the same for all the categories, and desirable values may be set for each category.

[Selection of Word of Interest (Step S210)]

Selection of the word of interest is carried out through the following steps S210-1 to S210-4 for each category. The word-of-interest selection unit 210 reads out candidates for the words that respectively represent a plurality of objects of interest for the target category, stored in the picture book material storage unit 250, from the picture book material storage unit 250 (step S210-1), causes the display unit 240 to display all of the candidates for the words that respectively represent the plurality of objects of interest, thus read out, as options (step S210-2), causes the input unit 230 to receive a selection operation performed by a user on one of the candidates displayed by the display unit 240 (step S210-3), selects the candidate for which the input unit 230 has received an selection operation, as the word that represents the object of interest, and stores the candidate in the target person information storage unit 260 (step S210-4).

[Selection of Unacquired Words (Step S220)]

Selection of unacquired words is carried out through the following steps S220-1 to S220-4 for each category. The unacquired word selection unit 220 reads out candidates for the words that respectively represent a plurality of unacquired words for the target category, stored in the picture book material storage unit 250, from the picture book material storage unit 250 (step S220-1), causes the display unit 240 to display all of the candidates for the unacquired words thus read out (step S220-2), causes the input unit 230 to receive a selection operation performed by a user regarding whether or not the target person can speak for each of the candidates displayed by the display unit 240 (step S220-3), selects the words for each of which the input unit 230 has received an selection operation indicating that the target person cannot speak the word, as the unacquired words, and stores the unacquired words in the target person information storage unit 260 (step S220-4).

[Acquisition of Target Person Information (Step S270)]

Note that when the picture book production information acquisition apparatus 200 is provided with the target person information acquisition unit 270, the target person information acquisition unit 270 may cause the display unit 240 to display a screen for inputting the name or nickname and sex of the target person, cause the input unit 230 to receive an input operation performed by the user regarding the name or nickname and sex of the target person, and store the input name or nickname and the sex of the target person in the target person information storage unit 260.

### Third Embodiment

In the third embodiment, an apparatus for producing a picture book according to the first embodiment, and operation thereof, will be described first.

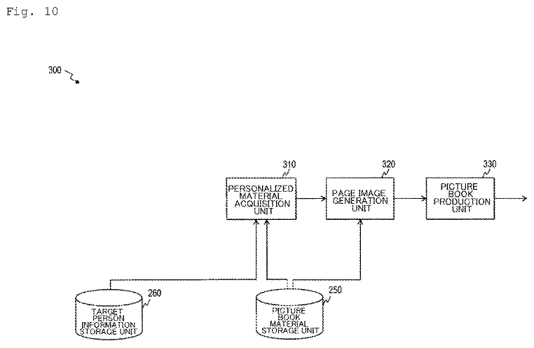

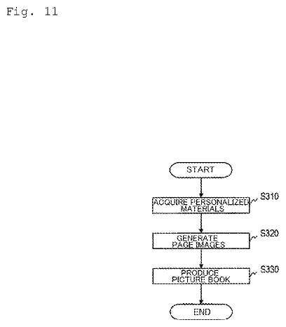

As with a picture book production apparatus 300 illustrated in FIG. 10, a picture book production apparatus according to the third embodiment includes, for example, a personalized material acquisition unit 310, a page image generation unit 320, a picture book production unit 330, a picture book material storage unit 250, and a target person information storage unit 260. The picture book production apparatus 300 according to the third embodiment is an apparatus for producing a picture book for each target person, and selects materials from the picture book material storage unit 250 based on information regarding the target person stored in the target person information storage unit 260, generates page images of the picture book using the selected materials, and manufacture a picture book that includes the generated page images. The picture book production apparatus 300 carries out steps S310 to S330 illustrated in FIG. 11, for each target person. When producing a picture book for one given target person, the picture book production apparatus 300 carries out steps S310 to S330 illustrated in FIG. 11 once for the target person.

[Picture Book Material Storage Unit 250]

The picture book material storage unit 250 is a storage unit that stores, in advance, pieces of image and text information that are materials of the picture book.

The picture book material storage unit 250 stores, for example, original images for the covers 110A and 110B of the picture books, original images for the introduction parts 120A and 120B, original images for the third double-page spreads 130A and 130B, original images for the second double-page spreads 140A and 140B, original images for the first double-page spreads 150A and 150B, original images for the closing parts 160A and 160B, and original images for the back covers. Each original image is an image that does not include a portion that is specialized for a target person. A portion that is specialized for a target person is, for example, in the case of the covers 110A and 110B illustrated in FIG. 1, the names or nicknames of the target persons in the titles 111A and 111B, and in the case of the first double-page spreads 150A and 150B illustrated in FIG. 5, the pictures 151A and 151B representing the objects of interest, the unacquired word pictures 152A-n and 152B-n, the question descriptions 153A and 153B, the character notations 154A and 154B of the words that represent the objects of interest, and the character notations 155A-n and 155B-n of the unacquired words.

In addition, for each of the categories to be included in each picture book, the picture book material storage unit 250 stores a plurality of sets (M sets, where M is an integer no less than 2) each consisting of the text of a candidate for the word that represents the object of interest, a picture representing the object of interest to which the candidate corresponds, and the text of a sentence regarding the object of interest, and a plurality of sets (L sets, where L is an integer greater than N) each consisting of the text of a candidate for unacquired words and a picture representing the unacquired word object to which the candidate corresponds. A plurality of texts of sentences regarding the object of interest may be included in each set, and the picture book material storage unit 250 stores them for a plurality of cases in which the texts of sentences regarding the object of interest are included in the picture book. In addition, it is preferable that the sets, each consisting of the text of a candidate for unacquired words and a picture representing the unacquired word object to which the candidate corresponds, are stored in the picture book material storage unit 250 so that the order of average acquisition ages can be seen. For example, the sets may be stored in order of the average acquisition ages, or the average acquisition ages may also be included in the sets and stored. Note that the number of sets to be stored in the picture book material storage unit 250 may be different for each category. That is to say, the values of the above-described M and L may be different for each category.

For example, for each of the three categories, namely “animal”, “food and drink”, and “others”, the picture book material storage unit 250 stores fifteen sets each consisting of the text of a candidate for the word that represents the object of interest, a picture representing the object of interest to which the candidate corresponds, and the text of a sentence regarding the object of interest. In addition, for example, the picture book material storage unit 250 stores twenty sets, each consisting of the text of a candidate for unacquired words and a picture representing the unacquired word object to which the candidate corresponds, for each of the three categories, namely “animal”, “food and drink”, and “others”.

The candidates for the word that represents the object of interest and the candidates for the unacquired words to be stored in the picture book material storage unit 250 are the same as the candidates for the word that represents the object of interest and the candidates for the unacquired words stored in the picture book material storage unit 250 of the picture book production information acquisition apparatus 200 according to the second embodiment.

The picture book material storage unit 250 stores picture images that represent infants for each sex. The picture book material storage unit 250 stores, for example, picture images representing male infants' faces and picture images representing female infants' faces, and may also store picture images representing male infants' figures and picture images representing female infants' figures.

[Target Person Information Storage Unit 260]

The target person information storage unit 260 is a storage unit that stores, in advance, information used to manufacture a picture book, for each target person. The target person information storage unit 260 stores, in advance, for each target person, a word that represents the object of interest, unacquired words, a name or a nickname, and a sex. These pieces of information stored in the target person information storage unit 260 in advance are, for example, those stored in the target person information storage unit 260 by the picture book production information acquisition apparatus 200 according to the second embodiment.

[Acquisition of Personalized Materials (Step S310)]

The personalized material acquisition unit 310 acquires images and texts for each target person, used for each part of the picture book, based on either the target person information storage unit 260 or the picture book material storage unit 250, and outputs them to the page image generation unit 320. In the case where images and texts for each target person used in each part of the picture book according to the first embodiment based on information regarding the target person acquired by the picture book production information acquisition apparatus 200 according to the second embodiment, the personalized material acquisition unit 310 performs the following operations.

[Acquisition of Name or Nickname]

The personalized material acquisition unit 310 acquires the name or nickname of the target person from the target person information storage unit 260 and outputs it. For example, when producing a picture book for a target person “Ellen”, the personalized material acquisition unit 310 acquires the text representing “Ellen” from the target person information storage unit 260 and outputs it.

[Acquisition of Picture Image Representing Infant]

The personalized material acquisition unit 310 acquires, from among picture images representing infants stored in the picture book material storage unit 250, an image corresponding to the sex of the target person stored in the target person information storage unit 260, and outputs it. For example, when producing a picture book for the target person “Ellen”, the personalized material acquisition unit 310 acquires, from among the picture images representing male infants' faces and picture images representing female infants' faces stored in the picture book material storage unit 250, picture images representing female infants' faces, which are images corresponding to the sex “female” of the target person “Ellen” stored in the target person information storage unit 260.

[Acquisition of Text Representing Object of Interest, Picture Image Representing Object of Interest, and Text of Sentence Regarding Object of Interest]

For each of the categories to be included in the picture book, the personalized material acquisition unit 310 acquires the text of a candidate for the word that represents the object of interest, a picture representing the object of interest to which the candidate corresponds, and the text of a sentence regarding the object of interest, included in the set (one set) that includes the text of the word that represents the object of interest of the target person stored in the target person information storage unit 260, from among the M sets stored in the picture book material storage unit 250, each consisting of the text of a candidate for the word that represents the object of interest, a picture representing the object of interest to which the candidate corresponds, and the text of a sentence regarding the object of interest, and outputs them. For example, in the case of producing a picture book for the target person “Ellen”, for the “animal” category to be included in the picture book, the personalized material acquisition unit 310 acquires a text “cat”, a picture image representing a “cat”, a text “the cat says meow, meow, meow”, a text “who are you with triangle ears?”, and a text “pat, pat, pat on your head” included in the set that includes text of the word “cat” that represents the object of interest of the target person “Ellen” stored in the target person information storage unit 260, from among the fifteen sets stored in the picture book material storage unit 250, each consisting of the text of a candidate for the word that represents the object of interest, a picture representing the object of interest to which the candidate corresponds, and the text of a sentence regarding the object of interest, and outputs them.

[Acquisition of Texts of Words representing Unacquired Word Objects and Picture Images Representing Unacquired Word Objects]

The personalized material acquisition unit 310 selects, for each of the categories to be included in the picture book, N unacquired words of the target person stored in the target person information storage unit 260 (i.e. N sets) from among L sets stored in the picture book material storage unit 250, each consisting of the texts of candidates for unacquired words, and picture images representing unacquired word objects to which the candidates respectively correspond, and acquires the texts of the words that represent the unacquired word objects and the picture images representing the unacquired word objects included in the selected sets, and outputs them. For example, regarding the “animal” category, if the number of unacquired words of the target person “Ellen” stored in the target person information storage unit 260 is twelve, L=20, and N=3, the personalized material acquisition unit 310 selects, from among twenty sets each consisting of a text of a candidate of a unacquired word and a picture image representing the unacquired word object corresponding to the candidate stored in the picture book material storage unit 250, sets (i.e. three sets) that include three of the twelve unacquired words of the target person “Ellen” stored in the target person information storage unit 260. Thereafter, the personalized material acquisition unit 310 acquires and outputs the texts of the words that represent the unacquired word objects and the picture images representing the unacquired word objects, included in the selected sets.

Note that, for each of the categories to be included in the picture book, if the number (K, where K is a positive integer) of unacquired words of the target person stored in the target person information storage unit 260 is greater than the number (N) to be selected, the personalized material acquisition unit 310 selects one word of the K unacquired words of the target person from each of the following ranges: the range from the smallest average acquisition age to the K/N^{th} average acquisition age, the range from the K/N+1^{th} average acquisition age to the 2K/N^{th} average acquisition age, . . . , the range from the (N−1)K/N+1^{th} average acquisition age to the K^{th} average acquisition age. If a plurality of words are included in a range, the personalized material acquisition unit 310 selects one word from the plurality of words at random. If K is not divisible by N, the personalized material acquisition unit 310 may use, instead of the value calculated through the above-described dividing operation, an integer value obtained by rounding down, rounding up, or rounding off the first decimal place of the value calculated through the dividing operation. When the personalized material acquisition unit 310 is to be operated in this way, the picture book material storage unit 250 may store the L sets each consisting of the text of a candidate for an unacquired word and the picture image representing the unacquired word object corresponding to the candidate so that the average acquisition age can be known. For example, the picture book material storage unit 250 may store the sets in order of average acquisition age, or store the average acquisition ages as well in the sets.

For example, the personalized material acquisition unit 310 selects sets (i.e., three sets) that respectively include three of the twelve unacquired word in the “animal” category of the target person “Ellen”, by selecting one word at random from each of the ranges, which are the range of four words from the smallest average acquisition age to the fourth average acquisition age, the range of four words from the fifth average acquisition age to the eighth average acquisition age, and the range of four words from the ninth average acquisition age to the twelfth average acquisition age, from among twelve unacquired words in the “animal” category of the target person “Ellen” stored in the target person information storage unit 260, of twenty sets each consisting of the text of a candidate for unacquired words and a picture image representing the unacquired word object to which the candidate corresponds stored in the picture book material storage unit 250, acquires the texts of the words that represent the unacquired word objects and the picture images representing the unacquired word object included in the selected sets, and outputs them. In this way, when N=3, the personalized material acquisition unit 310 can select, from among K unacquired words of the target person, the unacquired word α that the target person is likely to learn immediately and the picture αₚ corresponding to this unacquired word object, the unacquired word β that the target person is likely to learn a little later and the picture βₚ corresponding to this unacquired word object, and the unacquired word γ that the target person is likely to learn even later and the picture γₚ corresponding to this unacquired word object. That is to say, when if the value in the brackets is an integer value, INT( ) represent the integer value, and if the value in the brackets is a fractional value, INT( ) represents an integer value formed from the fractional value, the personalized material acquisition unit 310 may select, from among pictures presenting objects corresponding to words that the target person cannot speak, one word in the range from the smallest average acquisition age to the INT(K/3)^{th} average acquisition age as the picture αₚ of the object corresponding to the unacquired word α, one word in the range from the INT(K/3)+1^{th} average acquisition age to the INT(2K/3)^{th} average acquisition age as the picture βₚ of the object corresponding to the unacquired word β, and one word in the range from the INT(2K/3)+1^{th} average acquisition age to the K^{th} average acquisition age as the picture γₚ of the object corresponding to the unacquired word γ.

Note that, for the categories to be included in the picture book, if the number (K) of unacquired words of the target person stored in the target person information storage unit 260 is smaller than the number (N) of unacquired words to be selected, for the N−K unacquired words, the personalized material acquisition unit 310 may select sets that include N−K unacquired words in descending order of the average acquisition age, other than unacquired words of the target person stored in the target person information storage unit 260, from among the L sets each consisting of the text of a candidate for unacquired words and a picture image representing the unacquired word object to which the candidate corresponds stored in the picture book material storage unit 250, also acquire and output the texts of the words that represent the unacquired word objects and the picture images representing the unacquired word objects, included in the selected sets. Thus, although these N−K unacquired words are actually not unacquired words of the target person, it is possible to promote the establishment of words that the target person would have recently become able to speak.

[Generation of Page Image (step S320)]

The page image generation unit 320 generates page images for the parts of the picture book by inserting images and texts for the target person to be used in the parts of the picture book input from the personalized material acquisition unit 310, into the original images of the parts of the picture book input from the picture book material storage unit 250, i.e., images that do not include a portion specialized for the target person, in the parts of the picture book, and outputs them to the picture book production unit 330. For example, when generating the first double-page spread 150A, 150B of the main story part of the picture book, the page image generation unit 320 generates images for the first double-page spread 150A, 150B including a picture image representing the object of interest selected by the personalized material acquisition unit 310 and picture images representing plurality of unacquired word objects selected by the personalized material acquisition unit 310.

[Production of Picture Book (step S330)]

The picture book production unit 330 produces and outputs a picture book in which the images for the parts in the picture book input from the page image generation unit 320 are visualized. For example, the picture book production unit 330 prints the input images for the parts in the picture book on pieces of paper, and obtains a picture book by binding the pieces of paper obtained through printing, so as to include the cover 110A, 110B, the prologue part 120A, 120B, the third double-page spread 130A, 130B, the second double-page spread 140A, 140B, the first double-page spread 150A, 150B, the closing part 160A, 160B, and the back cover in this order, and outputs the picture book.

Note that, when producing a picture book according to a modification of the first embodiment, original images for the information part 170A, 170B are also stored in the picture book material storage unit 250 in advance, and the number of words that the target person has learnt so far, using the vocabulary building apparatus disclosed in Japanese Patent Application Publication No. 2019-101255, the words that the target person has already learnt, and the words that the target person is expected to learn from these words and information regarding the words such as the average acquisition ages of the words are also stored in the target person information storage unit 260 in advance, the personalized material acquisition unit 310 acquires the texts for the information part 170A, 170B from the target person information storage unit 260 and outputs them to the page image generation unit 320, and the page image generation unit 320 generates page images for the information part 170A, 170B from the original images for the information part 170A, 170B stored in the picture book material storage unit 250 and the texts output from the personalized material acquisition unit 310, and the picture book production unit 330 also prints the images for the information part 170A, 170B on a piece of paper, and obtains the picture book by binding the pieces of paper so that the information part 170A, 170B is sandwiched between the closing part 160A, 160B and the information part 170A, 170B, and outputs it.

<Modification of Third Embodiment>

Although the third embodiment describes an embodiment in which a physical picture book in which pieces of paper are bound is produced, the picture book according to the first embodiment is not necessarily a physical picture book, and may be an electronic picture book. A picture book producing apparatus 300 that produces an electronic picture book are different from the picture book producing apparatus 300 according to the third embodiment only in the operations of the picture book production unit 330. Specifically, the picture book production unit 330 obtains a picture by producing an electronic file that includes the input images for the parts of the picture book in the order described in the third embodiment, and outputs the picture book (step s330).

Note that, as in the case of a physical picture book where the third double-page spread 130A, 130B, the second double-page spread 140A, 140B, and the first double-page spread 150A, 150B each need to be two-page spread, each of these double-page spreads in the case of an electronic picture book needs to be displayable in one screen. That is to say, when a picture book is formed in a page-turning type electronic file, the picture book production unit 330 forms each of the third double-page spread 130A, 130B, the second double-page spread 140A, 140B, and the first double-page spread 150A, 150B so as to be a two-page spread as in the case of a physical picture book. In addition, when the picture book is a slide type electronic file for displaying one slide each time, the picture book production unit 330 may form each of the third double-page spread 130A, 130B, the second double-page spread 140A, 140B, and the first double-page spread 150A, 150B as one slide page.

### Fourth Embodiment

When producing the picture book according to the first embodiment, information regarding the target person may be acquired, and materials may be selected based on the acquired information, instead of selecting materials based on information regarding the target person that has already been stored as in the third embodiment. This embodiment will be described as a fourth embodiment.

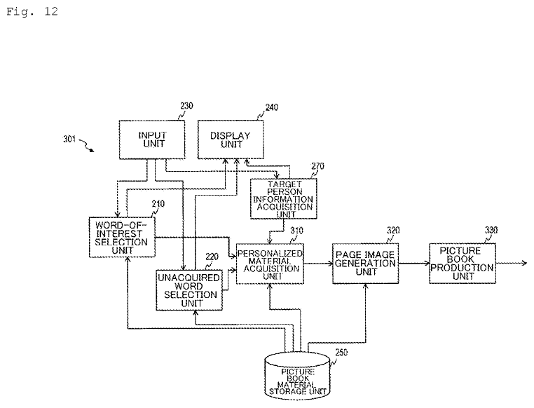

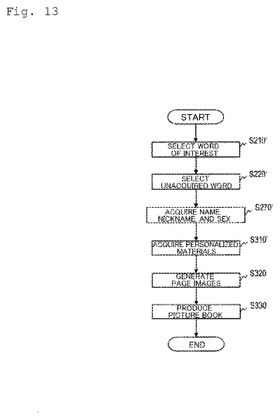

As with a picture book production apparatus 301 illustrated in FIG. 12, a picture book production apparatus according to the fourth embodiment includes, for example, the word-of-interest selection unit 210, the unacquired word selection unit 220, the target person information acquisition unit 270, the input unit 230, the display unit 240, the picture book material storage unit 250, the personalized material acquisition unit 310, the page image generation unit 320, and the picture book production unit 330. The picture book production apparatus 300 according to the fourth embodiment is for producing a picture book for each target person, in which the word-of-interest selection unit 210, the unacquired word selection unit 220, the target person information acquisition unit 270, the input unit 230, and the display unit 240 cooperate to acquire information regarding the target person, select materials based on the acquired information regarding the target person, from the picture book material storage unit 250, generate page images of the picture book using the selected materials, and produce a picture book that includes the generated page images. The picture book production apparatus 301 carries out step S210′, step S220′, step S270′, step S310′, step S320, and step S330 illustrated in FIG. 13 for each target person.

In the picture book production information acquisition apparatus 200 according to the second embodiment, the word-of-interest selection unit 210, the unacquired word selection unit 220, and the target person information acquisition unit 270 store the acquired information regarding the target person in the target person information storage unit 260, whereas, in the picture book production apparatus 301 according to the fourth embodiment, they output the acquired information regarding the target person to the personalized material acquisition unit 310. In the picture book production apparatus 300 according to the third embodiment, the personalized material acquisition unit 310 uses information regarding the target person stored in the target person information storage unit 260, whereas in the picture book production apparatus 301 according to the fourth embodiment, it uses the information regarding the target person acquired by the word-of-interest selection unit 210, the unacquired word selection unit 220, and the target person information acquisition unit 270. The following describes the picture book production apparatus 301 according to the fourth embodiment, while referencing the descriptions of the second embodiment and the third embodiment when necessary.

[Picture Book Material Storage Unit 250]

The picture book material storage unit 250 stores, in advance, the content stored in the picture book material storage unit 250 of the picture book production apparatus 300 according to the third embodiment and the content stored in the picture book material storage unit 250 of the picture book production information acquisition apparatus 200 according to the second embodiment. However, the content stored in the picture book material storage unit 250 of the picture book production apparatus 300 according to the third embodiment includes the content stored in the picture book production information acquisition apparatus 200 of the second embodiment. Therefore, the picture book material storage unit 250 may substantially be the same as the picture book material storage unit 250 of the picture book production apparatus 300 according to the third embodiment.

[Selection of Word of Interest (Step S210′)]

Selection of the word of interest is carried out through the following steps S210′-1 to S210′-4 for each category. The word-of-interest selection unit 210 reads out candidates for the words that respectively represent a plurality of objects of interest for the target category, stored in the picture book material storage unit 250, from the picture book material storage unit 250 (step S210′-1), causes the display unit 240 to display all of the candidates for the words that respectively represent the plurality of objects of interest, thus read out, as options (step S210′-2), causes the input unit 230 to receive a selection operation performed by a user on one of the candidates displayed by the display unit 240 (step S210′-3), selects the candidate for which the input unit 230 has received an selection operation, as the word that represents the object of interest, and outputs the candidate to the personalized material acquisition unit 310 (step S210′-4). That is to say, the operation performed by the picture book production apparatus 301 according to the fourth embodiment to select the word of interest (step S210′) is the same as step S210 in the second embodiment except that the word that represents the object of interest thus selected is output to the personalized material acquisition unit 310.

[Selection of Unacquired Words (Step S220′)]

Selection of unacquired words is carried out through the following steps S220′-1 to S220′-4 for each category. The unacquired word selection unit 220 reads out candidates for the words that respectively represent a plurality of unacquired words for the target category, stored in the picture book material storage unit 250, from the picture book material storage unit 250 (step S220′-1), causes the display unit 240 to display all of the candidates for the unacquired words thus read out (step S220′-2), causes the input unit 230 to receive a selection operation performed by a user regarding whether or not the target person can speak for each of the candidates displayed by the display unit 240 (step S220′-3), selects the words for each of which the input unit 230 has received an selection operation indicating that the target person cannot speak the word, as the unacquired words, and outputs the unacquired words to the personalized material acquisition unit 310 (step S220′-4). That is to say, the operation performed by the picture book production apparatus 301 according to the fourth embodiment to select unacquired words (step S220′) is the same as step S220 in the second embodiment except that the unacquired words thus selected are output to the personalized material acquisition unit 310.

[Acquisition of Target Person Information (Step S270′)]

The target person information acquisition unit 270 causes the display unit 240 to display a screen for inputting the name or nickname and sex of the target person, causes the input unit 230 to receive an input operation performed by the user regarding the name or nickname and sex of the target person, and outputs the input name or nickname and the sex of the target person to personalized material acquisition unit 310. That is to say, the operation performed by the picture book production apparatus 301 according to the fourth embodiment to acquire target person information (step S270′) is the same as step S270 in the second embodiment except that the name or nickname and sex of the target person thus input are output to the personalized material acquisition unit 310.

[Acquisition of Personalized Materials (Step S310′)]

The personalized material acquisition unit 310 outputs the images and texts for each target person to be used in the parts of the picture book obtained based on information regarding the word that represents the object of interest, input from the word-of-interest selection unit 210, information regarding unacquired words input from the unacquired word selection unit 220, information regarding the name or nickname and sex input from the target person information acquisition unit 270, and the content stored in the picture book material storage unit 250, to the page image generation unit 320. The operation performed by the personalized material acquisition unit 310 to acquire materials for each target person (step S310′) is the same as the operation performed by the personalized material acquisition unit 310 of the picture book production apparatus 300 according to the third embodiment except that the information regarding the target person acquired by the word-of-interest selection unit 210, the unacquired word selection unit 220, and the target person information acquisition unit 270 is used instead of the information regarding the target person stored in the target person information storage unit 260.

[Generation of Page Image (step S320)]

The page image generation unit 320 performs the same operation (step S320) as the page image generation unit 320 of the picture book production apparatus 300 according to the third embodiment.

[Manufacturing of Picture Book (step S330)]

The picture book production unit 330 performs the same operation (step S330) as the page picture book production unit 330 of the picture book production apparatus 300 according to the third embodiment.

<Modification of Fourth Embodiment>

The picture book production apparatus 301 according to the fourth embodiment may also produce an electronic picture book as with the picture book production apparatus 300 according to the modification of the third embodiment.

<Other Modifications, Etc.>

Note that the present invention is not limited to the above-described embodiments. For example, the picture book production information acquisition apparatus 200 according to the second embodiment, the apparatus including the input unit 230 and the display unit 240 of the picture book production apparatus 301 according to the fourth embodiment, and an apparatus including other units may be dispersedly arranged, and each kind of processing described above may be carried out by these apparatuses exchanging information with each other via the Internet or the like.

The picture book production information acquisition apparatus 200 according to the second embodiment, the picture book production apparatus 300 according to the modification of the third embodiment, and the picture book production apparatus 301 according to the modification of the fourth embodiment described above are realized using a computer, the content of processing functions that the apparatuses should have is to be written using programs. By executing the programs using a computer, the above-described processing functions are realized on the computer. An electronic file of programs that describe these processing contents and picture books may be recorded on a computer-readable recording medium. An example of a computer-readable recording medium is a non-transitory recording medium. Examples of such recording media include a magnetic recording device, an optical disk, an optical magnetic recording medium, a semiconductor memory, and so on.

Such programs and electronic files of picture books are distributed by, for example, selling, transferring, or renting portable recording media such as DVDs and CD-ROMs on which the programs and the electronic files of picture books are recorded. Furthermore, it is possible to employ a configuration with which the programs and the electronic files of picture books are stored in a storage device of a server computer, and the programs and the electronic files of picture books are distributed by transferring the programs and the electronic files of picture books from the server computer to other computers via a network.

A computer that executes such a program first temporarily stores, for example, a program recorded on a portable recording medium or a program transferred from a server computer, in its own storage device. When executing processing, the computer reads the program stored in its own storage device and executes processing according to the read program. In another mode of execution of such a program, the computer may read the program directly from the portable recording medium, and execute processing according to the program, and furthermore, the computer may execute processing according to a program every time a program is transferred to the computer from the server computer. It is also possible to employ a configuration with which the above-described processing is executed through a so-called ASP (Application Service Provider) type service in which a program is not transferred from the server computer to the computer and the processing functions are realized based only on the execution instruction and the acquisition of the results.

The processing functions of the apparatus are not necessarily realized by executing a program on a computer, and at least some of the processing functions may be realized using hardware.

### REFERENCE SIGNS LIST

110A, 110B Cover
120A, 120B Introduction part
130A, 130B Third double-page spread
140A, 140B Second double-page spread
150A, 150B First double-page spread
160A, 160B Closing part
170A, 170B Information part
200 Picture book production information acquisition apparatus
210 Word-of-interest selection unit
220 Unacquired word selection unit
230 Input unit
240 Display unit
250 Picture book material storage unit
260 Target person information storage unit
270 Target person information acquisition unit
300, 301 Picture book production apparatus
310 Personalized material acquisition unit
320 Page image generation unit
330 Picture book production unit

1-14. (canceled)

15. A picture book, in which pieces of paper are bound and which is specialized for the target infant person (hereinafter referred to as a “target person”), comprising:
a main story part including one or more a double-page spreads for a given category, wherein
the main story part includes a double-page spread (hereinafter referred to as a “first double-page spread”), and
the first double-page spread includes:
a picture that represents one object that the target person is interested in (hereinafter referred to as an “object of interest”), for the category; and
unacquired word pictures that are pictures that represent objects that respectively correspond to a plurality of words that the target person cannot speak, for the category.

16. The picture book according to claim 15,
wherein the picture that represents the object of interest is a picture that represents one object that has been selected in advance as what the target person is interested in, from among pictures for each of the plurality of candidates of the object of interest for the category, and
the unacquired word pictures are pictures that represents words that have been selected in advance as what the target person cannot speak, from among pictures for each of the plurality of candidates of the unacquired words for the category.

17. The picture book according to claim 15,
wherein the plurality of unacquired word pictures are a picture αₚ, a picture βₚ, and a picture γₚ that represent objects respectively corresponding to three words that the target person cannot speak, namely a word α, a word β, and a word γ, and
an average acquisition age of the word α is smaller than an average acquisition age of the word β, and an average acquisition age of the word γ is larger than the average acquisition age of the word β.

18. The picture book according to claim 15,
wherein the double-page spread includes a description for asking which is the object of interest.

19. The picture book according to claim 15,
wherein a base color of the picture representing the object of interest is different from a base color of at least one of the plurality of unacquired word pictures.

20. The picture book according to claim 15,
wherein the main story part includes a second double-page spread before the double-page spread,
wherein the second double-page spread
includes only the picture representing the object of interest, for the category, and
includes a text regarding the object of interest.

21. The picture book according to claim 20,
wherein the main story part includes a third double-page spread before the second double-page spread,
wherein the third double-page spread
includes only the picture representing the object of interest, for the category, and
includes a description for asking a question regarding the object of interest.

22. A picture book production apparatus comprising:
a picture book material storage unit that stores, in advance, for a given category, pictures respectively representing a plurality of candidates for an object that an infant targeted by a picture book is interested in (hereinafter referred to as “object-of-interest candidates”), and pictures respectively representing a plurality of candidates for objects corresponding to words that the infant targeted by the picture book cannot speak (hereinafter referred to as “unacquired word object candidates”);
a personalized material acquisition unit that acquires, for the category, a picture representing one object that a target person is interested in (hereinafter referred to as an “object of interest”) from among the pictures respectively representing the plurality of object-of-interest candidates stored in the picture book material storage unit, and acquires, for the category, unacquired word pictures that are pictures representing objects corresponding to the plurality of words that the target person cannot speak from among the pictures respectively representing the plurality of unacquired word object candidates stored in the picture book material storage unit;
a page image generation unit that generates images for a double-page spread that includes the picture representing the object of interest and the plurality of unacquired word pictures acquired by the personalized material acquisition unit; and
a picture book production unit that produces a picture book that includes a double-page spread formed by visualizing the images for the double-page spread generated by the page image generation unit.

23. The picture book production apparatus according to claim 22,
wherein the plurality of unacquired word pictures acquired by the personalized material acquisition unit are a picture αₚ, a picture βₚ, and a picture γₚ that represent objects respectively corresponding to three words, namely a word α, a word β, and a word γ, selected from among the words that the target person cannot speak, and
an average acquisition age of the word α is smaller than an average acquisition age of the word β, and an average acquisition age of the word γ is larger than the average acquisition age of the word β.

24. The picture book production apparatus according to claim 23,
wherein when the number of pictures representing the objects corresponding to the words that the target person cannot speak, of the pictures respectively representing the unacquired word object candidates stored in the picture book material storage unit, is K (K>3),
INT( ) represents a value in the brackets if the value is an integer value, and if the value in the brackets is a fractional value, represents an integer value formed from the fractional value,
one picture in a range from a picture corresponding to the smallest average acquisition age to a picture corresponding to INT(K/3)^{th} average acquisition age is selected as the picture αₚ representing the object corresponding to the word α, from among the pictures representing the objects corresponding to the words that the target person cannot speak,
one picture in a range from a picture corresponding to an INT(K/3)+1^{th} average acquisition age to a picture corresponding to an INT(2K/3)^{th} average acquisition age is selected as the picture βₚ representing the object corresponding to the word β, from among the pictures representing the objects corresponding to the words that the target person cannot speak, and
one picture in a range from a picture corresponding to an INT(2K/3)+1^{th} average acquisition age to a picture corresponding to a K^{th} average acquisition age is selected as the picture γₚ representing the object corresponding to the word γ, from among the pictures representing the objects corresponding to the words that the target person cannot speak.

25. A picture book production information acquisition apparatus comprising:
a picture book material storage unit that stores, in advance, for a given category,
a word that represents an object for a plurality of candidates for the object that an infant targeted by a picture book is interested in (hereinafter referred to as “object-of-interest candidates”), and
words that represent objects for a plurality of candidates for the objects corresponding to words that the infant targeted by the picture book cannot speak (hereinafter referred to as “unacquired word object candidates”);
a word-of-interest selection unit that causes a display unit to display, as options, all of the words that represent the object-of-interest candidates for the category stored in the picture book material storage unit, causes an input unit to receive a selection operation from a user selecting one of the words that represent the object-of-interest candidates displayed by the display unit, and selects, as a word that represents an object of interest of the target person, a word that represents an object-of-interest candidate for which the input unit has received the selection operation; and
an unacquired word selection unit that causes the display unit to display the words that represent the unacquired word object candidates for the category stored in the picture book material storage unit, causes the input unit to receive a selection operation from the user selecting, for each of the unacquired word object candidates displayed by the display unit, whether or not the target person can speak the unacquired word object candidate, and selects, as unacquired words, all of the words that represent unacquired word object candidates for which the input unit has received a selection operation indicating that the target person cannot speak words corresponding thereto.

26. A picture book production method,
wherein, for a given category, pictures respectively representing a plurality of candidates for an object that an infant targeted by a picture book is interested in (hereinafter referred to as “object-of-interest candidates”), and pictures respectively representing a plurality of candidates for objects corresponding to words that the infant targeted by the picture book cannot speak (hereinafter referred to as “unacquired word object candidates”) have been stored in advance in a picture book material storage unit, the picture book production method comprising:
a personalized material acquisition step of
acquiring, for the category, a picture representing one object that a target person is interested in (hereinafter referred to as an “object of interest”) from among the pictures respectively representing the plurality of object-of-interest candidates stored in the picture book material storage unit, and
acquiring, for the category, unacquired word pictures that are pictures representing objects corresponding to the plurality of words that the target person cannot speak from among the pictures respectively representing the plurality of unacquired word object candidates stored in the picture book material storage unit;
a page image generation step of generating images for a double-page spread that includes the picture representing the object of interest and the plurality of unacquired word pictures acquired in the personalized material acquisition step; and
a picture book production step of producing a picture book that includes a double-page spread formed by visualizing the images for the double-page spread generated in the page image generation step.

27. A picture book production information acquisition method,
wherein, for a given category,
a word that represents an object for a plurality of candidates for the object that an infant targeted by a picture book is interested in (hereinafter referred to as “object-of-interest candidates”), and
words that represent objects for a plurality of candidates for the objects corresponding to words that the infant targeted by the picture book cannot speak (hereinafter referred to as “unacquired word object candidates”)
have been stored in advance in a picture book material storage unit, the picture book production information acquisition method comprising:
a word-of-interest selection step of causing a display unit to display, as options, all of the words that represent the object-of-interest candidates for the category stored in the picture book material storage unit, causing an input unit to receive a selection operation from a user selecting one of the words that represent the object-of-interest candidates displayed by the display unit, and selecting, as a word that represents an object of interest of a target person, a word that represents an object-of-interest candidate for which the input unit has received the selection operation; and
an unacquired word selection step of causing the display unit to display the words that represent the unacquired word object candidates for the category stored in the picture book material storage unit, causing the input unit to receive a selection operation from the user selecting, for each of the unacquired word object candidates displayed by the display unit, whether or not the target person can speak the unacquired word object candidate, and selecting, as unacquired words, all of the words that represent unacquired word object candidates for which the input unit has received a selection operation indicating that the target person cannot speak words corresponding thereto.

28. A non-transitory computer-readable recording medium having recorded thereon a picture book production program for enabling a computer to function as the picture book production apparatus according to claim 22.

29. A non-transitory computer-readable recording medium having recorded thereon a picture book production information acquisition program for enabling a computer to function as the picture book production information acquisition apparatus according to claim 25.

30. A non-transitory computer-readable recording medium having recorded thereon a picture book of an electronic file, which is specialized for a target infant person (hereinafter referred to as a “target person”),
wherein, in the electronic file, an image for a double-page spread in the picture book is stored in a format where the image is displayable in one screen,
the picture book comprises a main story part including images for one or more a double-page spreads for a given category,
the main story part includes an image of a double-page spread (hereinafter referred to as a “first double-page spread”), and
the first double-page spread includes:
a picture that represents one object that the target person is interested in (hereinafter referred to as an “object of interest”), for the category; and
unacquired word pictures that are pictures that represent objects that respectively correspond to a plurality of words that the target person cannot speak, for the category.

31. A non-transitory computer-readable recording medium having recorded thereon a picture book of an electronic file, which is produced with the picture book production apparatus in claim 22 and specialized for the target infant person (hereinafter referred to as a “target person”),
wherein, in the electronic file, an image for a double-page spread in the picture book is stored in a format where the image is displayable in one screen,
the picture book comprises a main story part including images for one or more a double-page spreads for a given category,
the main story part includes an image of a double-page spread (hereinafter referred to as a “first double-page spread”),
the first double-page spread includes:
a picture that represents one object that the target person is interested in (hereinafter referred to as an “object of interest”), for the category; and
unacquired word pictures that are pictures that represent objects that respectively correspond to a plurality of words that the target person cannot speak, for the category,
the picture that represents the object of interest is a picture that represents one object that has been selected in advance as what the target person is interested in, from among pictures for each of the plurality of candidates of the object of interest for the category, and
the unacquired word pictures are pictures that represents words that have been selected in advance as what the target person cannot speak, from among pictures for each of the plurality of candidates of the unacquired words for the category.
